(19) United States
(12) Patent Application Publication
(10) Pub. No.: US 2026/0209634 A1
(43) Pub. Date: Jul. 23, 2026

(54) MULTI-LAYER LOW-FOAM LAUNDRY SHEET AND PREPARATION METHOD THEREOF

(71) Applicant: Guangzhou Joyson Cleaning Products Co., Ltd., Guangzhou (CN)

(72) Inventors: Fenglei LI, Guangzhou (CN); Jieer LUO, Guangzhou (CN); Min SUN, Guangzhou (CN); Jieting YAN, Guangzhou (CN); Junli LI, Guangzhou (CN)

(21) Appl. No.: 19/077,091

(22) Filed: Mar. 12, 2025

Related U.S. Application Data
(63) Continuation of application No. PCT/CN2025/073929, filed on Jan. 22, 2025.

(51) Int. Cl. C11D 1/831; C11D 1/10; C11D 1/14; C11D 1/28; C11D 1/29; C11D 1/66; C11D 1/72; C11D 1/74; C11D 3/00; C11D 3/04; C11D 3/20; C11D 3/22; C11D 3/37; C11D 11/00; C11D 17/04

(52) U.S. Cl. CPC C11D 1/831; C11D 3/001; C11D 3/044; C11D 3/046; C11D 3/2079; C11D 3/2086; C11D 3/225; C11D 3/3707; C11D 3/3753; C11D 11/0082; C11D 17/044; C11D 1/10; C11D 1/143; C11D 1/146; C11D 1/28; C11D 1/29; C11D 1/662; C11D 1/72; C11D 1/74

(57) ABSTRACT

The present application relates to a multi-layer low-foam laundry sheet and a preparation method thereof. The multi-layer low-foam laundry sheet consists of two or more single-layer laundry sheets by self-adhesion; wherein at least one single-layer laundry sheet is a single-layer laundry sheet A; the single-layer laundry sheet A is prepared from a slurry A, the slurry A includes film-forming agent A, anionic surfactant A, nonionic surfactant, acidifying agent, chelating agent, enzyme preparation A, auxiliary agent A, essence A, and water. The multi-layer low-foam laundry sheet of the present application has features of high cleaning power, low foam, and short dissolution time.

### CROSS-REFERENCE TO RELATED APPLICATION

The present continuation of PCT application serial no. PCT/CN2025/073929, filed on Jan. 22, 2025. The entirety of PCT application serial no. PCT/CN2025/073929 is hereby incorporated by reference herein and made a part of this specification.

### TECHNICAL FIELD

The present application relates to the field of laundry sheets, and more particularly, to a multi-layer low-foam laundry sheet and a preparation method thereof.

### BACKGROUND ART

At present, since the laundry gel beads and laundry sheets are put into use in a metered manner, the convenience of the laundry gel beads and laundry sheets is highly appreciated by consumers. The maximum weight of a laundry gel bead can reach 20 g, while the average weight of a laundry sheet is 4 g. Therefore, in practical use, compared with laundry gel beads, a limited surface-active agents carried by a single sheet of laundry sheet result in limited cleaning ability. The most straightforward solution to this problem today is to use several more laundry sheets.

While the use of multiple laundry sheets simultaneously or one multi-layer laundry sheet may have a beneficial effect on the cleaning power, the total active content increases multiple times, resulting in a multiple increase in the amount of foam, which tends to spill out of the washing machine during use, increasing the number of rinses and water usage during use.

In the preparation of a sheet slurry, certain bubbling and foaming properties are required, while low-foam and easy rinsing properties are required in the use of the finished product. This property makes it impossible to solve the problem of excessive foam caused by high total active substances by directly adding a defoamer or using low foam surfactant.

In view of the above, there is an urgent need to develop a multi-layer low-foam laundry sheet having high cleaning power.

### SUMMARY

In order to solve the above-mentioned problems, the present application provides a multi-layer low-foam laundry sheet and a preparation method thereof, wherein the multi-layer low-foam laundry sheet has features of high cleaning power, low foam, and short dissolution time.

In a first aspect, the present application provides a multi-layer low-foam laundry sheet, which adopts the following technical solution.

A multi-layer low-foam laundry sheet, consisting of two or more single-layer laundry sheets by self-adhesion;
wherein at least one single-layer laundry sheet is a single-layer laundry sheet A;
the single-layer laundry sheet A is prepared from a slurry A, based on a weight percentage of the slurry A, the slurry A includes the following raw materials:
10-30% of film-forming agent A, 20-50% of anionic surfactant A, 5-20% of nonionic surfactant, 2-10% of acidifying agent, 0.5-3% of chelating agent, 0-5% of enzyme preparation A, 1-5% of auxiliary agent A, 0.5-5% of essence A, and water;
the film-forming agent A includes polyvinyl alcohol;
the anionic surfactant A includes a high-foam surfactant and a low-foam surfactant; a weight ratio of the high-foam anionic surfactant to the low-foam anionic surfactant is (3-10):1;
the high-foam anionic surfactant includes at least one of sodium alpha-alkenyl sulfonate, sodium fatty acid methyl ester sulfonate, and sodium lauroyl glutamate;
the low-foam anionic surfactant includes at least one of sodium isomeric alcohol ether sulfate, sodium fatty acid methyl ester ethoxylate sulfonate, and sodium isooctanol sulfate; and
the nonionic surfactant includes at least two of EO/PO block polyether, fatty acid methyl ester ethoxylate, secondary alcohol ethoxylate, and alkyl glycoside alkoxylate.

The alkyl glycoside alkoxylate, secondary alcohol ethoxylate, and fatty acid methyl ester ethoxylate have weak interactions between hydrophilic and lipophilic groups in the molecule and do not readily form large amounts of foam. Fatty acid methyl ester ethoxylate sulfonate and sodium modified oil ethoxylate sulfonate have both anionic and nonionic properties, belonging to anionic-non-amphoteric surfactants. Due to the introduction of sulfonic acid groups, the molecular polarity of fatty acid methyl ester ethoxylate sulfonate and sodium modified oil ethoxylate sulfonate is enhanced, allowing them to interact more easily with water molecules in solution, thereby further reducing the generation of foam. In solution, the molecules offatty acid methyl ester ethoxylate sulfonate and sodium modified oil ethoxylate sulfonate can form a stable micelle structure, and the interaction between these micelles is weak, not readily forming large amounts of foam.

The polyoxyethylene group in the EO/PO block polyether is a hydrophilic group and the polyoxypropylene group is a lipophilic group. This structure makes EO/PO block polyether easier to form micelles in an aqueous solution, and the surface tension is higher. At the same time, the hydrophilic and lipophilic groups are mixed and arranged alternately, obstructing each other in space and forming a large number of voids between liquid films, weakening the strength of liquid films and making a wall of a formed foam film more prone to rupture.

In the present application, the high-foam surfactant is the main surfactant, and a specific low-foam surfactant is compatible. By a synergistic action of two types of the surfactants, on the one hand, in the process of preparing the slurry, a certain density of foam can be generated, which ensures the thickness and rich pores of a finished multi-layer laundry sheet, and when the multi-layer laundry sheet is used, water molecules can enter the sheet layer from the pores, thereby accelerating the dissolution rate; on the other hand, when used, the multi-layer low-foam laundry sheet prepared in the present application not only has a low-foam amount, but also has a fast defoaming rate, which can reduce the rinsing times and water usage, and is of great significance for energy saving and emission reduction; and at the same time, it ensures a high detergency effect and has a variety of excellent properties.

Preferably, a weight ratio of the anionic surfactant A to the nonionic surfactant is (2-10):1.

Preferably, the chelating agent includes at least one of citric acid, gluconic acid, glutamic acid diacetic acid, and methylglycine diacetic acid.

Preferably, the enzyme preparation A includes at least one of a liquid preparation and a solid preparation.

Preferably, the enzyme preparation A includes at least one of protease, amylase, lipase, cellulase, phosphodiesterase, pectinase, and mannanase.

Preferably, the auxiliary agent A includes a C3-C18 polyol.

Preferably, the C3-C18 polyol includes at least one of glycerol, glycerol, butanediol, hexanediol, and octanediol.

Preferably, the single-layer laundry sheet further includes a single-layer laundry sheet B, wherein the single-layer laundry sheet B is prepared from a slurry B, based on a weight percentage of the slurry B, the slurry B includes the following raw materials: 3-20% of film-forming agent B, 10-30% of anionic surfactant B, 5-10% of softening agent, 2-10% of alkalizing agent, 0-5% of enzyme preparation B, 1-5% of auxiliary agent B, 0.5-5% of essence B, and water;
the film-forming agent B includes at least sodium alginate and carboxymethyl cellulose, a weight ratio of sodium alginate to carboxymethyl cellulose is (1-15):1; and
the anionic surfactant B includes at least one of sodium alpha-alkenyl sulfonate, sodium alkyl sulfate, sodium modified oil ethoxylate sulfonate, and sodium fatty acid methyl ester sulfonate.

Preferably, the sodium alkyl sulfate includes at least one of sodium dodecyl sulfate, sodium tetradecyl sulfate, sodium hexadecyl sulfate, sodium octadecyl sulfate, and sodium eicosanyl sulfate.

Preferably, the acidifying agent includes a C12-C18 fatty acid.

Preferably, the C12-C18 fatty acid includes at least one of lauric acid, oleic acid, stearic acid, and palmitic acid.

Preferably, the alkalizing agent includes at least one of sodium/potassium hydroxide, sodium/potassium carbonate, and sodium/potassium citrate.

By adopting the above technical solution, since the single-layer laundry sheet A contains the fatty acid and the single-layer laundry sheet B contains the alkalizing agent, when the single-layer laundry sheet A and the single-layer laundry sheet B are self-adhered, a fatty acid salt “saponified layer” is slowly formed between the layers at a high temperature, further promoting self-adhesion between the layers. When the multi-layer laundry sheet is dissolved in water, the fatty acid salt can form a film layer similar to mineral oil on the surface of the liquid to further reduce the surface tension, thereby inhibiting the generation of foam. At the same time, the fatty acid salt can further have an affinity with the liquid molecules inside the foam, causing the foam to rupture and destroying the stability of the foam.

The addition of the fatty acid salt directly to the slurry affects the foamability of the slurry, so that the formation of the fatty acid salt “saponified layer” during the preparation of the multi-layer laundry sheet avoids the above problems, while further reducing the amount of foam during use of the multi-layer laundry sheet.

Preferably, the softening agent includes at least one of natural phyllosilicate, hydrolyzed wheat protein/silicone copolymer, and amino silicone oil.

In the present application, the specific categories of the enzyme preparation B and the auxiliary agent B are the same as the enzyme preparation A and the auxiliary agent A, respectively.

Preferably, the single-layer laundry sheet A is located at an outermost layer of the multi-layer low-foam laundry sheet.

Preferably, the single-layer laundry sheet A is located at the outermost layer of the multi-layer low-foam laundry sheet, and the single-layer laundry sheet B is located at a middle of the multi-layer low-foam laundry sheet.

Preferably, a thickness of the single-layer laundry sheet A is 0.3-3.5 mm, and a thickness of the single-layer laundry sheet B is 0.3-3.0 mm.

Preferably, layers of the single-layer laundry sheet of the multi-layer low-foam laundry sheet are self-adhered by a smooth side of one layer and a rough side of another layer.

Preferably, in the multi-layer low-foam laundry sheet, the solid preparation in the enzyme preparation A and enzyme preparation B is preferably completely encapsulated between layers, and the liquid preparation and the solid preparation may not be added in the same layer of the laundry sheet at the same time.

In a second aspect, the present application provides a method for preparing the multi-layer low-foam laundry sheet, which adopts the following technical solution:

A method for preparing the multi-layer low-foam laundry sheet, including the following steps:
step 1: preparing the slurry A, including the following steps:
step 1a: mixing and stirring water and the film-forming agent A under a condition of 75-85° C., and after the film-forming agent swells uniformly, adding an anionic surfactant A and stirring to dissolve uniformly; and
step 1b: then adding the remaining raw materials of slurry A and stirring until uniform to obtain the slurry A;
if the slurry A includes the enzyme preparation A, when the enzyme preparation A includes a liquid enzyme preparation, then adding the remaining raw materials except the liquid enzyme preparation in step 1b, and after cooling to 58-63° C., adding the liquid enzyme preparation so as to be mixed uniformly to obtain the slurry A; when the enzyme preparation A includes a solid enzyme preparation, then adding the remaining raw materials except the solid enzyme preparation in step 1b, and adding the solid enzyme preparation by means of spraying when drying to form a sheet in step 3;
step 2: if a single-layer laundry sheet B is included, then preparing the slurry B, including the following steps:
step 2a: mixing water and the film-forming agent B, and fully swelling to a homogeneous viscous liquid under a condition of 20-30° C.;
step 2b: adding the anionic surfactant B and the auxiliary agent B under a condition of 38-45° C. and stirring to dissolve uniformly; and
step 2c: then adding the remaining raw materials of slurry B to obtain the slurry B;
if the slurry B includes the enzyme preparation B, when the enzyme preparation B includes the liquid enzyme preparation, adding the liquid enzyme preparation in step 2b to mix uniformly to obtain the slurry B; when the enzyme preparation B includes the solid enzyme preparation, then adding the remaining raw materials except the solid enzyme preparation in step 2b, and adding the solid enzyme preparation by means of spraying when drying to form a sheet in step 3;
if the single-layer laundry sheet B is not included, omitting this step, and performing step 3 after step 1 is finished;
step 3: during a drying and forming stage of a slurry for preparing any single-layer laundry sheet, attaching another single-layer or multi-layer laundry sheet that has completed the drying and forming stage, and then continuing drying to obtain the multi-layer low-foam laundry sheet.

When single-layer laundry sheets of the same type are self-adhered, a semi-finished sheet in the drying stage has a higher viscosity, and can adhere tightly to another finished sheet. However, when single-layer laundry sheet A and single-layer laundry sheet B of different types are adhered to each other, due to the special “saponification layer” effect, a tight adhesion effect can also be achieved, obtaining a multi-layer low-foam laundry sheet with good detergency effect, low foam, and instant dissolution.

In summary, the present application has the following beneficial effects:
1. The low-foam surfactant, such as the sodium isomeric alcohol ether sulfate, used in the present application not only reduces the amount of foaming during the washing process but also accelerates the dissolution rate of the laundry sheet. In addition, the single-layer laundry sheet prepared by the combination of the specially selected nonionic surfactant, anionic surfactant, and film-forming agent can have a rich pore structure, ensuring that the laundry sheet has a certain thickness while having a low-foam effect.
2. When the multi-layer laundry sheet is dissolved in water, the fatty acid salt can form a mineral oil-like film layer on the surface of the liquid, further reducing the surface tension and promoting dissolution.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a cross-sectional microscopic image of a double-layer low-foam laundry sheet of Example 1.

FIG. 2 is a cross-sectional microscopic image of a three-layer low-foam laundry sheet of Example 3.

FIG. 3 is a physical image of the three-layer low-foam laundry sheet of Example 3.

FIG. 4 is a cross-sectional microscopic image of a four-layer low-foam laundry sheet of Example 6.

FIG. 5 is a physical image of a single-layer laundry sheet A1 of a double-layer low-foam laundry sheet of Comparative Example 2.

FIG. 6 is an image showing that a single-layer laundry sheet B prepared in Comparative Example 7 cannot be formed.

FIG. 7 shows results of the storage stability test of the double-layer laundry sheets of Comparative Examples 1-3.

FIG. 8 shows results of the storage stability test of the double-layer laundry sheets of Comparative Examples 4-6, and Comparative Example 8.

FIG. 9 shows results at 0 min and 5 min of Examples 1-3 in foam height testing.

FIG. 10 shows results at 0 min and 5 min of Examples 4-6 in foam height testing.

FIG. 11 shows results at 0 min and 5 min of Comparative Example 1, Comparative Examples 4, and 5 in foam height testing.

FIG. 12 shows results at 0 min and 5 min of Comparative Example 6 in foam height testing.

### DETAILED DESCRIPTION

The present application will be further described in detail with reference to the drawings and examples.

The raw materials used in the following examples and comparative examples are all commercially available.

The following are some sources of the raw materials:

The alkyl glycoside alkoxylate was purchased from the China Research Institute of Daily Chemical Industry, under Item. No. APG-NF.

Sodium isomeric alcohol ether sulfate was purchased from China Research Institute of Daily Chemical Industry, under Item. No. CYS-221.

The sodium modified oil ethoxylate sulfonate was purchased from China Research Institute of Daily Chemical Industry, under Item. No. SNS-80.

Hydrolyzed wheat protein/silicone copolymer was purchased from Croda, under Item. No. Coltide HSI-LQ-(SG).

The natural phyllosilicate was purchased from BYK GmbH, Germany, under Item. No. PURABYK-P 5540.

EO/PO block polyether was purchased from BASF GmbH, Germany, under Item. No. Pluronic PE 6100.

The secondary alcohol ethoxylate was purchased from Dow Chemical, under Item. No. ECOSURF™LF-30.

### EXAMPLES

### Example 1

A double-layer low-foam laundry sheet consisted of a single-layer laundry sheet A1 and a single-layer laundry sheet A2 by self-adhesion.

The single-layer laundry sheet A1 was prepared from a slurry A1 including, based on weight percent, the following raw materials: 28% of polyvinyl alcohol, 30% of sodium alpha-alkenyl sulfonate, 5% of sodium isomeric alcohol ether sulfate, 5% of alkyl glycoside alkoxylate, 5% of fatty acid methyl ester ethoxylate, 3% of lauric acid, 1% of citric acid, 1% of solid protease, 2% of glycerol, 1% of essence, 0.1% of dye, and 18.9% of water.

The single-layer laundry sheet A2 was prepared from a slurry A2 including, based on weight percent, the following raw materials: 25% of polyvinyl alcohol, 17% of sodium fatty acid methyl ester sulfonate, 10% of sodium alpha-alkenyl sulfonate, 3% of sodium fatty acid methyl ester ethoxylate sulfonate, 3% of sodium isooctanol sulfate, 6% of secondary alcohol ethoxylate, 7% of EO/PO block polyether, 2% of stearic acid, 1% of citric acid, 2% of propylene glycol, 1% of essence, and 23% of water.

After testing, the thickness of the single-layer laundry sheet A was most preferably 0.3-3.5 mm, and the thickness of the single-layer laundry sheet B was most preferably 0.3-3.0 mm. The amount of the slurry can be set according to practical conditions to obtain a single-layer laundry sheet with a corresponding thickness.

In this example, further provided is a method for preparing the double-layer low-foam laundry sheet including the following steps:
Step 1: preparing the slurry A1, including the following steps:
Step 1a: the water and polyvinyl alcohol were mixed and heated to 80° C. under stirring; after the polyvinyl alcohol swelled uniformly, the sodium alpha-alkenyl sulfonate and sodium isomeric alcohol ether sulfate were added, stirred until fully dissolved, then heating was stopped; and
Step 1b: the alkyl glycoside alkoxylate, fatty acid methyl ester ethoxylate, lauric acid, citric acid, glycerol, essence, and dye were successively added, stirred until fully dissolved to obtain the slurry A1;
Step 2: preparing slurry A2 including the following steps.
Step 2a: the water and polyvinyl alcohol were mixed and heated to 80° C. under stirring; after the polyvinyl alcohol swelled uniformly, the sodium fatty acid methyl ester ethoxylate sulfonate, sodium fatty acid methyl ester sulfonate, sodium alpha-alkenyl sulfonate, and sodium isooctanol sulfate were added, stirred until fully dissolved, then heating was stopped; and
Step 2b: the EO/PO block polyether, secondary alcohol ethoxylate, stearic acid, citric acid, propylene glycol, and essence were successively added, stirred until fully dissolved to obtain the slurry A2;
Step 3: the slurry A1 was dried and formed into a sheet, and the solid protease was added by means of spraying during the drying and forming process to obtain the single-layer laundry sheet A1; and
Step 4: during drying the slurry A2, the single-layer laundry sheet A1 was attached to the surface of a semi-formed single-layer laundry sheet A2, and drying was continued to obtain the double-layer low-foam laundry sheet.

The semi-dry self-adhesion operation allows the layers of the single-layer laundry sheets of the double-layer low-foam laundry sheet to be in a self-adhesion of a smooth side of one layer and a rough side of the other layer.

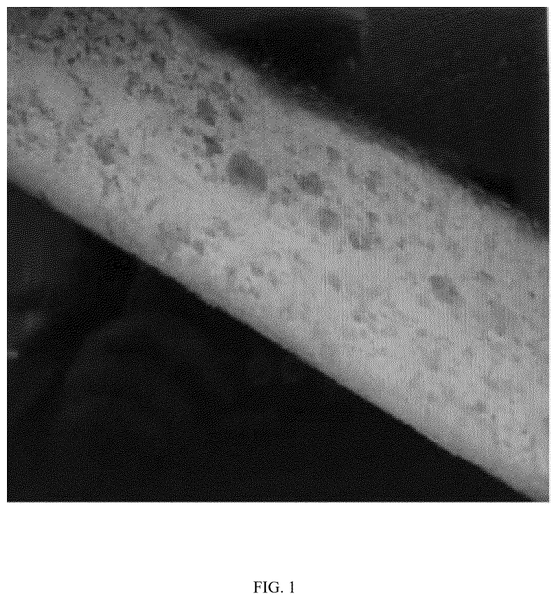

The cross-sectional microscopic image of the double-layer low-foam laundry sheet was shown in FIG. 1.

### Example 2

A double-layer low-foam laundry sheet consisted of a single-layer laundry sheet A and a single-layer laundry sheet B by self-adhesion.

The single-layer laundry sheet A was prepared from slurry A including, based on weight percent, the following raw materials: 28% of polyvinyl alcohol, 20% of sodium lauroyl glutamate, 5% of sodium isomeric alcohol ether sulfate, 2% of alkyl glycoside alkoxylate, 3% of secondary alcohol ethoxylate, 2% of lauric acid, 1% of citric acid, 2% of butylene glycol, 1% of essence, and 36% water.

The single-layer laundry sheet B was prepared from slurry B including, based on weight percent, the following raw materials: 10% of sodium alginate, 2% of carboxymethyl cellulose, 25% of sodium alkyl sulfate, 8% of hydrolyzed wheat protein/silicone copolymer, 3% of sodium hydroxide, 2% of octanediol, 1% of liquid protease, 1% of essence, and 48% of water.

In this example, the sodium alkyl sulfate was sodium dodecyl sulfate.

In this example, further provided is a method for preparing the double-layer low-foam laundry sheet including the following steps:
Step 1: preparing slurry A, including the following steps:
Step 1a: the water and polyvinyl alcohol were mixed and heated to 75° C. under stirring; after the polyvinyl alcohol swelled uniformly, the sodium lauroyl glutamate and sodium isomeric alcohol ether sulfate were added, stirred until fully dissolved, then heating was stopped; and
Step 1b: the alkyl glycoside alkoxylate, secondary alcohol ethoxylate, lauric acid, citric acid, butanediol, and essence were successively added, stirred until fully dissolved to obtain the slurry A;
Step 2: preparing slurry B, including the following steps:
Step 2a: the water, sodium alginate, and carboxymethyl cellulose were mixed, and allowed to stand at 20° C. to fully swell to form a homogeneous viscous liquid;
Step 2b: the temperature was heated to 38° C.; then the sodium alkyl sulfate and octanediol were added, stirred until fully dissolved; and
Step 2c: the hydrolyzed wheat protein/silicone copolymer, sodium hydroxide, liquid protease, and essence were continued to be added, and stirred until fully dissolved to obtain the slurry B;
Step 3: the slurry A was dried and formed into a sheet to obtain the single-layer laundry sheet A; and
Step 4: during drying the slurry B, the single-layer laundry sheet A was attached to the surface of a semi-formed single-layer laundry sheet B, and drying was continued to obtain the double-layer low-foam laundry sheet.

### Example 3

A three-layer low-foam laundry sheet consisted of a single-layer laundry sheet A1, a single-layer laundry sheet B, and a single-layer laundry sheet A2 by self-adhesion.

The first layer: the single-layer laundry sheet A1 was prepared from a slurry A1 including, based on weight percent, the following raw materials: 20% of polyvinyl alcohol, 16% of sodium fatty acid methyl ester sulfonate, 7% of sodium alpha-alkenyl sulfonate, 7% of sodium lauroyl glutamate, 5% of sodium fatty acid methyl ester ethoxylate sulfonate, 4% of sodium isomeric alcohol ether sulfate, 1% of sodium isooctanol sulfate, 10% of alkyl glycoside alkoxylate, 5% of EO/PO block polyether, 3% of secondary alcohol ethoxylate, 5% of oleic acid, 1% of gluconic acid, 2% of hexanediol, 1% of essence, and 13% of water.

The second layer: the single-layer laundry sheet B was prepared from a slurry B including, based on weight percent, the following raw materials: 4% of sodium alginate, 4% of carboxymethyl cellulose, 15% of sodium modified oil ethoxylate sulfonate, 13% of sodium alpha-alkenyl sulfonate, 5% of natural phyllosilicate, 5% of sodium carbonate, 2% of glycerol, 1% of essence, 0.1% of dye, 1% of solid protease, and 49.9% of water.

The third layer: the single-layer laundry sheet A2 was prepared from a slurry A2 including, based on weight percent, the following raw materials: 18% of polyvinyl alcohol, 23% of sodium lauroyl glutamate, 5% of sodium fatty acid methyl ester sulfonate, 3.5% of sodium isooctanol sulfate, 2% of secondary alcohol ethoxylate, 2% of alkyl glycoside alkoxylate, 1% of EO/PO block polyether, 1% of fatty acid methyl ester ethoxylate, 3% of palmitic acid, 1% of citric acid, 1% of liquid protease, 2% of propylene glycol, 1% of essence, and 36.5% of water.

In this example, further provided is a method for preparing the three-layer low-foam laundry sheet, including the following steps:
Step 1: preparing slurry A1, including the following steps.
Step 1a: the water and polyvinyl alcohol were mixed and heated to 85° C. under stirring; after the polyvinyl alcohol swelled uniformly, the sodium fatty acid methyl ester sulfonate, sodium alpha-alkenyl sulfonate, sodium lauroyl glutamate, sodium fatty acid methyl ester ethoxylate sulfonate, sodium isomeric alcohol ether sulfate, and sodium isooctanol sulfate were added, stirred until fully dissolved, then the heating was stopped; and
Step 1b: the alkyl glycoside alkoxylate, EO/PO block polyether, secondary alcohol ethoxylate, oleic acid, gluconic acid, hexanediol, and essence were successively added, and stirred until fully dissolved to obtain the slurry A1;
Step 2: preparing slurry B, including the following steps:
Step 2a: the water, sodium alginate, and carboxymethyl cellulose were mixed, and allowed to stand at 30° C. to fully swell to form a homogeneous viscous liquid;
Step 2b: the temperature was heated to 45° C., then the sodium modified oil ethoxylate sulfonate, sodium alpha-alkenyl sulfonate, and glycerol were added, stirred until fully dissolved; and
Step 2c: the natural phyllosilicate, sodium carbonate, essence, and dye were continued to be added, stirred until fully dissolved to obtain the slurry B;
Step 3: preparing slurry A2 including the following steps:
Step 3a: the water and polyvinyl alcohol were mixed and heated to 80° C. under stirring; after the polyvinyl alcohol swelled uniformly, the sodium fatty acid methyl ester sulfonate and sodium isooctanol sulfate were added, stirred until fully dissolved, then heating was stopped;
Step 3b: the EO/PO block polyether, fatty acid methyl ester ethoxylate, secondary alcohol ethoxylate, alkyl glycoside alkoxylate, palmitic acid, citric acid, propylene glycol, and essence were successively added, and stirred until fully dissolved; and
Step 3c: the temperature was cooled to 60° C., and the liquid protease was continued to be added, stirred until fully dissolved to obtain the slurry A2;
Step 4: the slurry A1 was dried and formed into a sheet to obtain the single-layer laundry sheet A1;
Step 5: the slurry B was dried and formed into a sheet; and
the solid protease was added by means of spraying during the drying and forming process;
after spraying the solid protease, and drying the slurry B to a semi-dry state, the single-layer laundry sheet A1 was attached to the surface of a semi-formed single-layer laundry sheet B, and drying was continued to obtain the single-layer laundry sheet A1, and the single-layer laundry sheet B in self-adhesion;
the single-layer laundry sheet A1 and the single-layer laundry sheet B in self-adhesion were at this time were defined as a semi-finished product;
Step 6: during drying the slurry A2, the semi-finished product obtained in step 5 was attached to the surface of a semi-formed single-layer laundry sheet A2, and drying was continued to obtain the three-layer low-foam laundry sheet.

The single-layer laundry sheet B in the semi-finished product was in surface contact with the semi-formed single-layer laundry sheet A2.

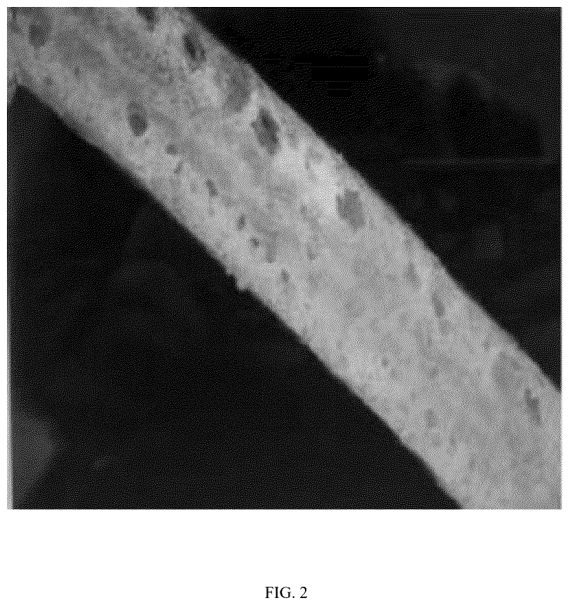

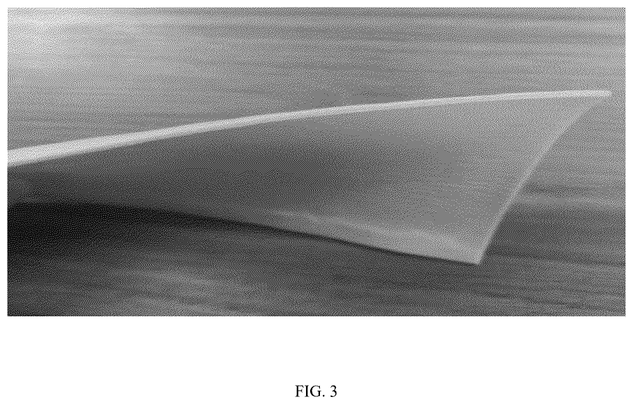

The cross-sectional micrograph of the three-layer low-foam laundry sheet was shown in FIG. 2, and clear pores can be seen. A physical image of the three-layer low-foam laundry sheet was shown in FIG. 3.

### Example 4

A three-layer low-foam laundry sheet consisted of a single-layer laundry sheet A1, a single-layer laundry sheet B, and a single-layer laundry sheet A2 by self-adhesion.

It differed from Example 3 in that some of the raw material content of slurry B of the second layer was different. Specifically, slurry B included, based on weight percent, the following raw materials: 10% of sodium alginate, 1% of carboxymethyl cellulose, 15% of sodium modified oil ethoxylate sulfonate, 13% of sodium alpha-alkenyl sulfonate, 5% of natural phyllosilicate, 5% of sodium carbonate, 2% of glycerol, 1% of essence, 0.1% of dye, 1% of solid protease, and 46.9% of water.

### Example 5

A three-layer low-foam laundry sheet consisted of a single-layer laundry sheet A1, a single-layer laundry sheet A3, and a single-layer laundry sheet A2 by self-adhesion.

It differed from Example 3 in that the second layer was a single-layer laundry sheet A3.

The single-layer laundry sheet A3 was prepared from slurry A3 including, based on the weight percent of slurry A3, the following raw materials: 15% of polyvinyl alcohol, 13% of sodium lauroyl glutamate, 5% of sodium alpha-alkenyl sulfonate, 2.5% of sodium isomeric alcohol ether sulfate, 2% of fatty acid methyl ester ethoxylate, 1% of alkyl glycoside alkoxylate, 1% of EO/PO block polyether, 1.5% of secondary alcohol ethoxylate, 3% of lauric acid, 1% of citric acid, 1% of solid protease, 2% of glycerin, 1% of essence, 0.1% of dye, and 50.9% of water.

Further, in the method for preparing the three-layer low-foam laundry sheet, step 2 became: preparing a slurry A3, including the following steps:
Step 2a: the water and polyvinyl alcohol were mixed and heated to 85° C. under stirring;
after the polyvinyl alcohol swelled uniformly, the sodium alpha-alkenyl sulfonate, sodium lauroyl glutamate, and sodium isomeric alcohol ether sulfate were added, stirred until fully dissolved, then heating was stopped; and
Step 2b: the alkyl glycoside alkoxylate, fatty acid methyl ester ethoxylate, EO/PO block polyether, secondary alcohol ethoxylate, lauric acid, citric acid, glycerol, essence, and dye were successively added, stirred until fully dissolved to obtain the slurry A3.

### Example 6

A four-layer low-foam laundry sheet consisted of a single-layer laundry sheet A1, a single-layer laundry sheet B1, a single-layer laundry sheet B2, and a single-layer laundry sheet A2 by self-adhesion. The first and second layers were the same as those of Example 3, and the fourth layer was substantially the same as the third layer of Example 3.

The fourth layer differed from the third layer of Example 3 in that 0.1% of dye was added to the fourth layer and the amount of water was correspondingly reduced by 0.1%. This was only an easy discrimination of layers from layer to layer and didn't affect the actual efficacy.

The slurry of the third layer of single-layer laundry sheet B2 consisted of the following raw materials: 14% of sodium alginate, 1% of carboxymethyl cellulose, 15% of sodium fatty acid methyl ester sulfonate, 5% of sodium alpha-alkenyl sulfonate, 5% of natural phyllosilicate, 5% of sodium carbonate, 2% of glycerol, 1% of essence, and 52% of water.

A method for preparing the four-layer low-foam laundry sheet included the following steps:
Step 1: preparing slurry A1, including the following steps:
Step 1a: the water and polyvinyl alcohol were mixed and heated to 85° C. under stirring; after the polyvinyl alcohol swelled uniformly, the sodium fatty acid methyl ester sulfonate, sodium alpha-alkenyl sulfonate, sodium lauroyl glutamate, sodium fatty acid methyl ester ethoxylate sulfonate, sodium isomeric alcohol ether sulfate, and sodium isooctanol sulfate were added, stirred until fully dissolved, then the heating was stopped; and
Step 1b: the alkyl glycoside alkoxylate, EO/PO block polyether, secondary alcohol ethoxylate, oleic acid, gluconic acid, hexanediol, and essence were successively added, and stirred until fully dissolved to obtain the slurry A1; Step 2: preparing slurry B1, including the following steps:
Step 2a: the water, sodium alginate, and carboxymethyl cellulose were mixed, and allowed to stand at 30° C. to fully swell to form a homogeneous viscous liquid;
Step 2b: the temperature was heated to 45° C., then the sodium modified oil ethoxylate sulfonate, sodium alpha-alkenyl sulfonate, and glycerol were added, stirred until fully dissolved; and
Step 2c: the natural phyllosilicate, sodium carbonate, essence, and dye were continued to be added, stirred until fully dissolved to obtain the slurry B1;
Step 3: preparing slurry B2, including the following steps:
Step 3a: the water, sodium alginate, and carboxymethyl cellulose were mixed, and allowed to stand at 30° C. to fully swell to form a homogeneous viscous liquid;
Step 3b: the temperature was heated to 45° C., then the sodium fatty acid methyl ester sulfonate, sodium alpha-alkenyl sulfonate, and glycerol were added, stirred until fully dissolved; and
Step 3c: the natural phyllosilicate, sodium carbonate, essence, and dye were continued to be added, stirred until fully dissolved to obtain the slurry B2;
Step 4: preparing slurry A2, including the following steps:
Step 4a: the water and polyvinyl alcohol were mixed and heated to 80° C. under stirring; after the polyvinyl alcohol swelled uniformly, the sodium fatty acid methyl ester sulfonate and sodium isooctanol sulfate were added, stirred until fully dissolved, then heating was stopped;
Step 4b: the EO/PO block polyether, fatty acid methyl ester ethoxylate, secondary alcohol ethoxylate, alkyl glycoside alkoxylate, palmitic acid, citric acid, propylene glycol, and essence were successively added, and stirred until fully dissolved; and
Step 4c: the temperature was cooled to 60° C., and the liquid protease was continued to be added, stirred until fully dissolved to obtain the slurry A2;
Step 5: the slurry A1 was dried and formed into a sheet to obtain the single-layer laundry sheet A1;
Step 6: the slurry B1 was dried and formed into a sheet; and
the solid protease was added by means of spraying during the drying and forming process;
after spraying the solid protease, and drying the slurry B to a semi-dry state, the single-layer laundry sheet A1 was attached to the surface of a semi-formed single-layer laundry sheet B1, and drying was continued to obtain a single-layer laundry sheet A1 and a single-layer laundry sheet B1 in self-adhesion.
the single-layer laundry sheet A1 and the single-layer laundry sheet B1 in self-adhesion were at this time defined as a first semi-finished product;
Step 7: during drying the slurry B2, the first semi-finished product obtained in step 6 was attached to the surface of a semi-formed single-layer laundry sheet B2, and continued to be formed into a sheet to obtain a second semi-finished product;
the single-layer laundry sheet B1 was in surface contact with the semi-formed single-layer laundry sheet B2;
Step 8: during drying the slurry A2, the second semi-finished product obtained in step 7 was attached to the surface of a semi-formed single-layer laundry sheet A2, and drying was continued to obtain the four-layer low-foam laundry sheet.

The single-layer laundry sheet B2 was in surface contact with the semi-formed single-layer laundry sheet A2.

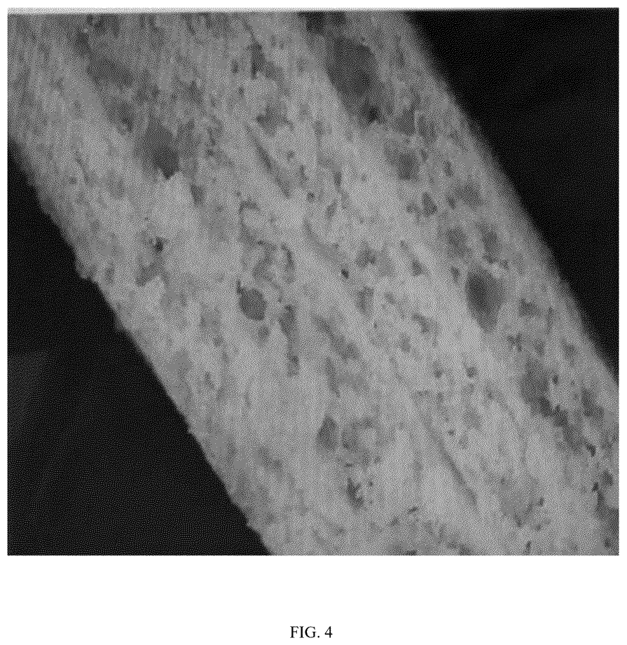

The cross-sectional micrograph of the four-layer low-foam laundry sheet was shown in FIG. 4.

### COMPARATIVE EXAMPLES

### Comparative Example 1

A double-layer laundry sheet included two single-layer laundry sheets adhered by a liquid protease and an adhesive.

Specifically, the single-layer laundry sheet included the following preparation materials: 35% of polyvinyl alcohol, 19% of sodium dodecyl benzene sulfonate, 20% of sodium alpha-olefin sulfonate, 6% of fatty alcohol polyoxyethylene ether, 2% of sodium citrate, 1.3% of glycerol, 1% of liquid protease, 0.1% pigment, and 15.6% of deionized water.

A method for preparing the single-layer laundry sheet includes the following steps.

The polyvinyl alcohol and deionized water were added to a batching pot. A resulting mixture was stirred and pre-dissolved for 30 min. The temperature was controlled at 60° C. until fully dissolved.

The sodium dodecyl benzene sulfonate, sodium alpha-olefin sulfonate, fatty alcohol polyoxyethylene ether, glycerol, sodium citrate, and pigment were added to the batching pot were added. The temperature of the batching pot was controlled at 80° C. and stirred for 50 min to obtain a homogeneous slurry.

The slurry was transferred to a drying drum at 100° C. and dried to form the single-layer laundry sheet.

A method for preparing the double-layer laundry sheet included the following steps.

Two single-layer laundry sheets were taken, and the liquid protease was applied to the surface of each single-layer laundry sheet.

The above two single-layer laundry sheets coated with the liquid protease were adhered and pressed together using a fusing machine, and then the double-layer laundry sheet was prepared by hot shearing, punching, and packaging.

### Comparative Example 2

A double-layer low-foam laundry sheet consisted of a single-layer laundry sheet A1 and a single-layer laundry sheet A2 by self-adhesion.

It differed from Example 1 in that some of the raw materials of slurry A1 and slurry A2 were different, specifically:

The single-layer laundry sheet A1 was prepared from a slurry A1 including, based on weight percent, the following raw materials: 28% of polyvinyl alcohol, 35% of sodium isomeric alcohol ether sulfate, 5% of alkyl glycoside alkoxylate, 5% of fatty acid methyl ester ethoxylate, 3% of lauric acid, 1% of citric acid, 1% of liquid protease, 2% of glycerin, 1% of essence, 0.1% of dye, and 18.9% of water.

The single-layer laundry sheet A2 was prepared from a slurry A2 including, based on weight percent, the following raw materials: 25% of polyvinyl alcohol, 30% of sodium fatty acid methyl ester ethoxylate sulfonate, 3% of sodium isooctanol sulfate, 6% of secondary alcohol ethoxylate, 7% of EO/PO block polyether, 2% of stearic acid, 1% of citric acid, 2% of propylene glycol, 1% of essence, and 23% of water.

A method for preparing the double-layer low-foam laundry sheet differed from Example 1 in that: some of steps 1 and 2 were different and the rest were the same.

Specifically, step 1 included the following steps:
Step 1a: the water and polyvinyl alcohol were mixed and heated to 80° C. under stirring; after the polyvinyl alcohol swelled uniformly, the sodium isomeric alcohol ether sulfate was added, stirred until fully dissolved, then heating was stopped; and
Step 1b: the alkyl glycoside alkoxylate, fatty acid methyl ester ethoxylate, lauric acid, citric acid, glycerol, essence, liquid protease, and dye were successively added, and stirred until fully dissolved to obtain the slurry A1.

Step 2 included the following steps:
Step 2a: the water and polyvinyl alcohol were mixed and heated to 80° C. under stirring;
after the polyvinyl alcohol swelled uniformly, sodium fatty acid methyl ester ethoxylate sulfonate and sodium isooctanol sulfate were added, stirred until fully dissolved, then heating was stopped; and
Step 2b: the EO/PO block polyether, secondary alcohol ethoxylate, stearic acid, citric acid, propylene glycol, and essence were successively added, and stirred until fully dissolved to obtain the slurry A2.

Since neither of the single-layer laundry sheets A1 and A2 of this comparative example used a high-foam surfactant, the forming of the single-layer laundry sheet was very poor, and the slurry flowed backward to form waterfall marks during the forming. Moreover, the single-layer laundry sheet was thin and easily floated in water, resulting in slow dissolution.

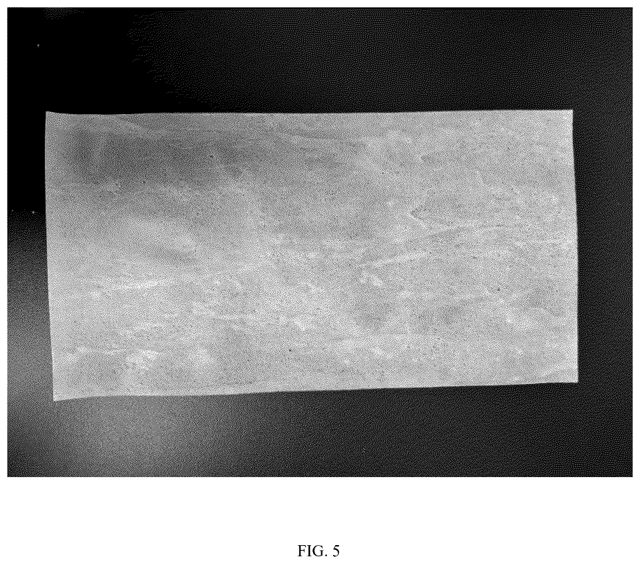

A physical image of the single-layer laundry sheet A1 was shown in FIG. 5.

### Comparative Example 3

A double-layer low-foam laundry sheet differed from Example 1 in that both the single-layer laundry sheets A1 and A2 used sodium dodecyl benzene sulfonate in an equal amount instead of sodium alpha-alkenyl sulfonate.

### Comparative Example 4

A double-layer low-foam laundry sheet consisted of a single-layer laundry sheet A1 and a single-layer laundry sheet A2 by self-adhesion.

It differed from Example 1 in that some of the raw materials of slurry A1 and slurry A2 were different, specifically:

The single-layer laundry sheet A1 was prepared from the slurry A1 including, based on weight percent, the following raw materials: 28% of polyvinyl alcohol, 35% of sodium alpha-alkenyl sulfonate, 5% of alkyl glycoside alkoxylate, 5% of fatty acid methyl ester ethoxylate, 3% of lauric acid, 1% of citric acid, 1% of liquid protease, 2% of glycerin, 1% of essence, 0.1% of dye, and 18.9% of water.

The single-layer laundry sheet A2 was prepared from a slurry A2 including, based on weight percent, the following raw materials: 25% of polyvinyl alcohol, 17% of sodium fatty acid methyl ester sulfonate, 13% of sodium alpha-alkenyl sulfonate, 3% of sodium isooctanol sulfate, 6% of secondary alcohol ethoxylate, 7% of EO/PO block polyether, 2% of stearic acid, 1% of citric acid, 2% of propylene glycol, 1% of essence, and 23% of water.

A method for preparing the double-layer low-foam laundry sheet differed from Example 1 in that: some of steps 1 and 2 were different and the rest were the same.

Specifically, step 1 included the following steps:
Step 1a: the water and polyvinyl alcohol were mixed and heated to 80° C. under stirring; after the polyvinyl alcohol swelled uniformly, the sodium alpha-alkenyl sulfonate was added, stirred until fully dissolved, then heating was stopped; and
Step 1b: the alkyl glycoside alkoxylate, fatty acid methyl ester ethoxylate, lauric acid, citric acid, glycerol, essence, liquid protease, and dye were successively added, stirred until fully dissolved to obtain the slurry A1.

Step 2 included the following steps:
Step 2a: the water and polyvinyl alcohol were mixed and heated to 80° C. under stirring; after the polyvinyl alcohol swelled uniformly, the sodium fatty acid methyl ester sulfonate, sodium alpha-alkenyl sulfonate, and sodium isooctanol sulfate were added, stirred until fully dissolved, then heating was stopped; and
Step 2b: the EO/PO block polyether, secondary alcohol ethoxylate, stearic acid, citric acid, propylene glycol, and essence were added, and stirred until fully dissolved to obtain the slurry A2.

### Comparative Example 5

A double-layer low-foam laundry sheet differed from Example 1 in that some of the raw materials of slurry A1 and slurry A2 were different, specifically:

A single-layer laundry sheet A1 was prepared from a slurry A1 including, based on weight percent, the following raw materials: 28% of polyvinyl alcohol, 30% of sodium alpha-alkenyl sulfonate, 5% of sodium isomeric alcohol ether sulfate, 3% of lauric acid, 1% of citric acid, 1% of solid protease, 2% of glycerol, 1% of essence, 0.1% of dye, and 28.9% of water.

A single-layer laundry sheet A2 was prepared from a slurry A2 including, based on weight percent, the following raw materials: 25% of polyvinyl alcohol, 17% of sodium fatty acid methyl ester sulfonate, 10% of sodium alpha-alkenyl sulfonate, 3% of sodium fatty acid methyl ester ethoxylate sulfonate, 3% of sodium isooctanol sulfate, 2% of stearic acid, 1% of citric acid, 2% of propylene glycol, 1% of essence, and 36% of water.

A method for preparing the double-layer low-foam laundry sheet differed from Example 1 in that: some of steps 1 and 2 were different and the rest were the same.

Specifically, step 1 included the following steps: the water and polyvinyl alcohol were mixed and heated to 80° C. under stirring; after the polyvinyl alcohol swelled uniformly, the sodium alpha-alkenyl sulfonate, sodium isomeric alcohol ether sulfate, lauric acid, citric acid, glycerol, essence, and dye were added, stirred until fully dissolved to obtain the slurry A1.

Step 2 included preparing slurry A2 including the following steps: the water and polyvinyl alcohol were mixed and heated to 80° C. under stirring; after the polyvinyl alcohol swelled uniformly, sodium fatty acid methyl ester ethoxylate sulfonate, sodium fatty acid methyl ester sulfonate, sodium alpha-alkenyl sulfonate, sodium isooctanol sulfate, stearic acid, citric acid, propylene glycol and essence were added, stirred until fully dissolved to obtain the slurry A2.

### Comparative Example 6

A double-layer low-foam laundry sheet consisted of a single-layer laundry sheet A1 and a single-layer laundry sheet A2 by self-adhesion.

It differed from Example 1 in that some of the raw materials of slurry A1 and slurry A2 were different, specifically:
The single-layer laundry sheet A1 was prepared from the slurry A1 including, based on weight percent, the following raw materials: 28% of polyvinyl alcohol, 30% of sodium alpha-alkenyl sulfonate, 5% of sodium isomeric alcohol ether sulfate, 5% of alkyl glycoside, 5% of fatty alcohol polyoxyethylene ether, 3% of lauric acid, 1% of citric acid, 1% of liquid protease, 2% of glycerin, 1% of essence, 0.1% of dye, and 18.9% of water.

The single-layer laundry sheet A2 was prepared from the slurry A2 including, based on weight percent, the following raw materials: 25% of polyvinyl alcohol, 17% of sodium fatty acid methyl ester sulfonate, 10% of sodium alpha-alkenyl sulfonate, 3% of sodium fatty acid methyl ester ethoxylate sulfonate, 3% of sodium isooctanol sulfate, 13% of coco fatty acid diethanolamide, 2% of stearic acid, 1% of citric acid, 2% of propylene glycol, 1% of essence, and 23% of water.

A method for preparing the double-layer low-foam laundry sheet differed from Example 1 in that: some of steps 1 and 2 were different and the rest were the same.

Specifically, step 1 included the following steps:
Step 1a: the water and polyvinyl alcohol were mixed and heated to 80° C. under stirring; after the polyvinyl alcohol swelled uniformly, the sodium alpha-alkenyl sulfonate and sodium isomeric alcohol ether sulfate were added, stirred until fully dissolved, then heating was stopped; and
Step 1b: the alkyl glycoside, fatty alcohol polyoxyethylene ether, lauric acid, citric acid, glycerol, essence, liquid protease, and dye were successively added, stirred until fully dissolved to obtain a slurry A1.

Step 2: preparing slurry A2, including the following steps:
Step 2a: the water and polyvinyl alcohol were mixed and heated to 80° C. under stirring; after the polyvinyl alcohol swells uniformly, the sodium fatty acid methyl ester ethoxylate sulfonate, sodium fatty acid methyl ester sulfonate, sodium alpha-alkenyl sulfonate, and sodium isooctanol sulfate were added, stirred until fully dissolved, then heating was stopped; and
Step 2b: the coco fatty acid diethanolamide, stearic acid, citric acid, propylene glycol and essence were successively added, stirred until fully dissolved to obtain the slurry A2.

### Comparative Example 7

A double-layer low-foam laundry sheet consisted of a single-layer laundry sheet A and a single-layer laundry sheet B by self-adhesion.

It differed from Example 2 in that components of the single-layer laundry sheet B were adjusted.

The single-layer laundry sheet B was prepared from a slurry B including, based on weight percent, the following raw materials: 12% of carboxymethyl cellulose, 25% of sodium alkyl sulfate, 8% of hydrolyzed wheat protein/silicone copolymer, 3% of sodium hydroxide, 2% of octanediol, 1% of liquid protease, 1% of essence, and 48% of water.

A method for preparing the double-layer low-foam laundry sheet differed from Example 2 in that some of step 2 were different.

Specifically, step 2 included the following steps:
Step 2a: the water and carboxymethyl cellulose were mixed and allowed to stand at 20° C. to fully swell to form a homogeneous viscous liquid;
Step 2b: the temperature was heated to 38° C., then the sodium alkyl sulfate and octanediol were added, stirred until fully dissolved; and
Step 2c: the hydrolyzed wheat protein/silicone copolymer, sodium hydroxide, liquid protease, and essence were continued to be added, and stirred until fully dissolved to obtain the slurry B.

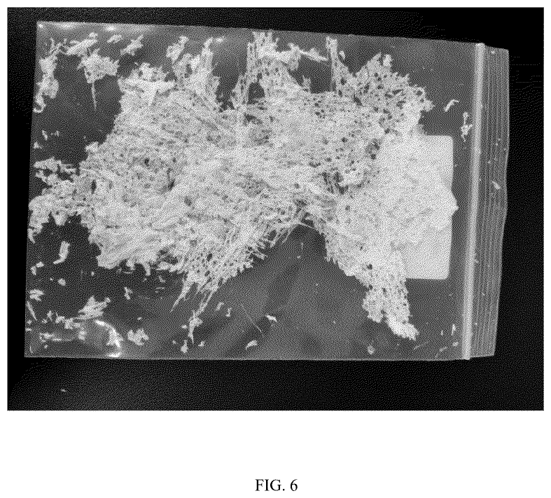

When the slurry B was dried alone to prepare the single-layer laundry sheet B, it was found that the sheet could not be formed, and the actual situation was shown in FIG. 6.

Therefore, the corresponding double-layer low-foam laundry sheet could not be obtained in this comparative example, and subsequent testing could not be performed.

### Comparative Example 8

A double-layer low-foam laundry sheet consisted of a single-layer laundry sheet A and a single-layer laundry sheet B by self-adhesion.

It differed from example 2 in that components of the single-layer laundry sheet B were adjusted.

The single-layer laundry sheet B was prepared from a slurry B including, based on weight percent, the following raw materials: 20% of sodium alginate, 25% of sodium alkyl sulfate, 8% of hydrolyzed wheat protein/silicone copolymer, 3% of sodium hydroxide, 2% of octanediol, 1% of liquid protease, 1% of essence, and 40% of water.

A method for preparing the double-layer low-foam laundry sheet differed from Example 2 in that: some of step 2 were partially different and the rest were the same.

Specifically, step 2 included the following steps:
Step 2a: the water and sodium alginate were mixed and allowed to stand at 20° C. to fully swell to a homogeneous viscous liquid;
Step 2b: the temperature was heated to 38° C., then the sodium alkyl sulfate and octanediol were added, stirred until fully dissolved; and
Step 2c: the hydrolyzed wheat protein/silicone copolymer, sodium hydroxide, liquid protease, and essence were continued to be added, and stirred until fully dissolved to obtain the slurry B.

### Performance Testing Experiment

Test I: detergency test

According to GB/T 13174-2021 “Determination of detergency and cycle of washing property for laundry detergents”, the washing water was 250 mg/kg CaCl₂) hard water, and the test cloth was national standard carbon black JB-01 dirty cloth, national standard protein JB-02 dirty cloth, and national standard sebum JB-03 dirty cloth.

0.2% standard laundry detergent was taken as a control. The samples were cut into small pieces (2 cm*2 cm) with an equal area of 2 cm*2 cm, and then prepared to sample solutions by using 1 L of hard water, so as to obtain the detergency ratio Pi.

The detection results were respectively shown in Table 1.

When Pi≥1.0 is qualified, and Pi<1.0 is unqualified.

$${P}_{i} = \frac{Δ A}{Δ B}$$

ΔA is the whiteness difference before and after washing the test cloth with the laundry sheet;
ΔB is the whiteness difference before and after washing the test cloth with standard laundry detergent.

TABLE 1

| | National | | |
|---|---|---|---|
| | standard carbon | National | National |
| | black | standard protein | standard sebum |
| Grouping | dirty cloth | dirty cloth | dirty cloth |
| Example 1 | 1.40 | 3.04 | 1.82 |
| Example 2 | 1.32 | 2.04 | 1.76 |
| Example 3 | 1.46 | 3.57 | 2.00 |
| Example 4 | 1.49 | 3.61 | 1.96 |
| Example 5 | 1.42 | 3.28 | 1.87 |
| Example 6 | 1.53 | 4.15 | 2.18 |
| Comparative | 1.20 | 2.08 | 1.13 |
| Example 1 | | | |
| Comparative | 1.23 | 2.25 | 1.29 |
| Example 2 | | | |
| Comparative | 1.30 | 2.21 | 1.36 |
| Example 3 | | | |
| Comparative | 1.24 | 2.33 | 1.31 |
| Example 4 | | | |
| Comparative | 1.23 | 2.48 | 1.27 |
| Example 5 | | | |
| Comparative | 1.31 | 2.32 | 1.30 |
| Example 6 | | | |

Test II: Storage Stability

One multi-layer laundry sheet was stored in a test environment at a temperature of (25±2)° C. and a relative humidity of (50±5) % for 30 days. After the test, one multi-layer laundry sheet was separated to observe whether it could be completely torn into a single-layer laundry sheet, and the results are recorded in Table 2.

Phenomena were classified as complete torn (layer-to-layer can be completely separated without breakage), incomplete torn (layer-to-layer can be completely separated but with breakage), and failure to tear.

TABLE 2

| Grouping | Morphology |
|---|---|
| Example 1 | Failure to tear |
| Example 2 | Failure to tear |
| Example 3 | Failure to tear |
| Example 4 | Failure to tear |
| Example 5 | Failure to tear |
| Example 6 | Failure to tear |
| Comparative | Complete torn |
| Example 1 | |
| Comparative | Incomplete torn |
| Example 2 | |
| Comparative | Incomplete torn |
| Example 3 | |
| Comparative | Incomplete torn |
| Example 4 | |
| Comparative | Incomplete torn |
| Example 5 | |
| Comparative | Incomplete torn |
| Example 6 | |
| Comparative | Incomplete torn |
| Example 8 | |

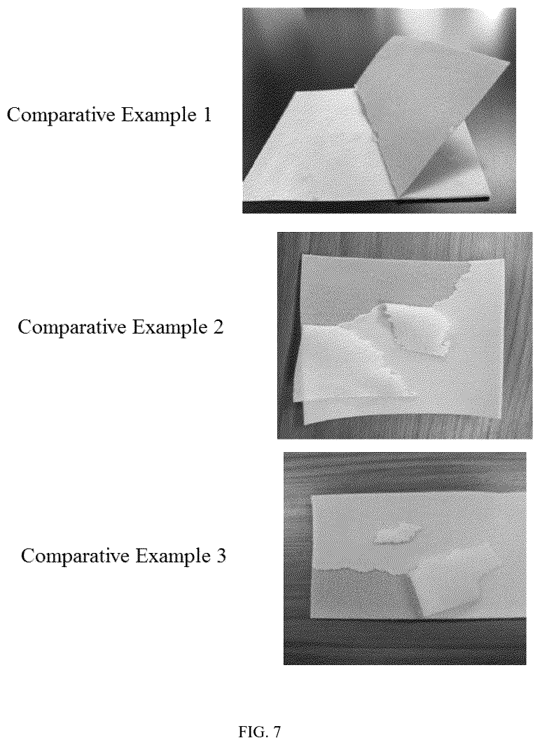

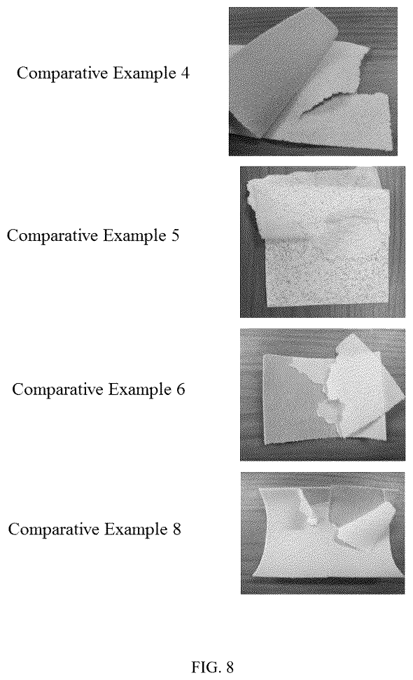

The state images of the test results for the double-layer detergent sheets of Comparative Examples 1-6 and Comparative Example 8 are shown in FIGS. 7-8.
Test III: dissolution time

According to QB/T5779-2023 “laundry sheets”, 700 mL of hard water (250 mg/kg calcium chloride) was placed in a 1 L beaker and placed in a water bath at (23±2° C.) The stirring speed of magnetic stirring was adjusted. The double/multi-layer laundry sheets were cut into 3 cm*3 cm square pieces, and, at 10 cm parallel to the water surface, vertically cast into the beaker.

The timing was started when the laundry sheet touched the water surface, and timing was ended when the sample was completely dispersed in the water to obtain the dissolution time.

3 times were repeated in parallel.

The results were recorded in Table 3.

TABLE 3

| | Dissolution | |
|---|---|---|
| Grouping | time | |
| Example 1 | 55 | sec |
| Example 2 | 40 | sec |
| Example 3 | 65 | sec |
| Example 4 | 66 | sec |
| Example 5 | 60 | sec |
| Example 6 | 70 | sec |
| Comparative | 240 | sec |
| Example 1 | | |
| Comparative | 152 | sec |
| Example 2 | | |
| Comparative | 105 | sec |
| Example 3 | | |
| Comparative | 117 | sec |
| Example 4 | | |
| Comparative | 120 | sec |
| Example 5 | | |
| Comparative | 124 | sec |
| Example 6 | | |
| Comparative | 75 | sec |
| Example 8 | | |

Test IV: Foam Height

According to GB/T 13173-2021 “Surface active agents—Test methods for detergents”, the double/multi-layer laundry sheets were prepared as 1% solutions with 250 mg/L hard water. Foam heights at 0 and 5 min were recorded using a Ross—Miles foamer at 40° C.

The results were recorded in Table 4.

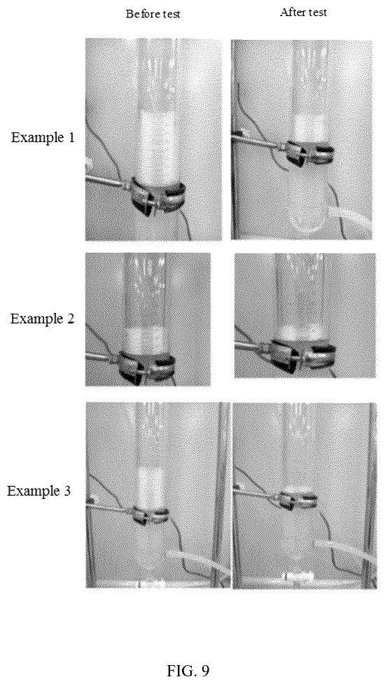

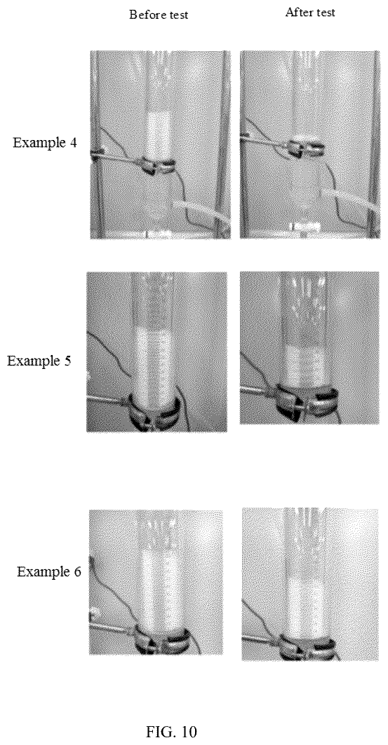

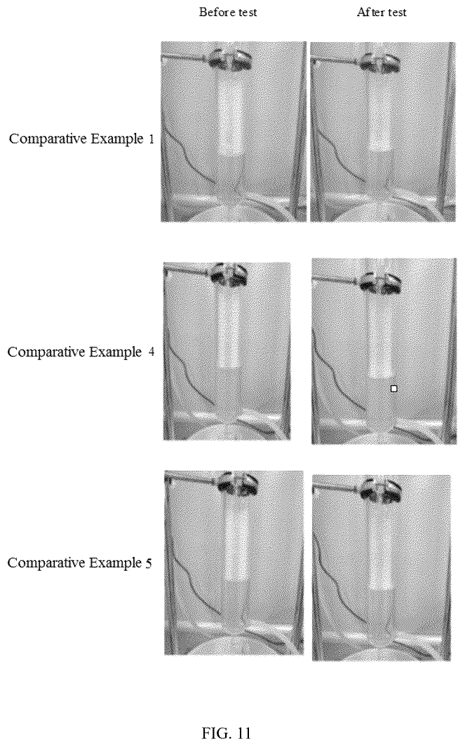

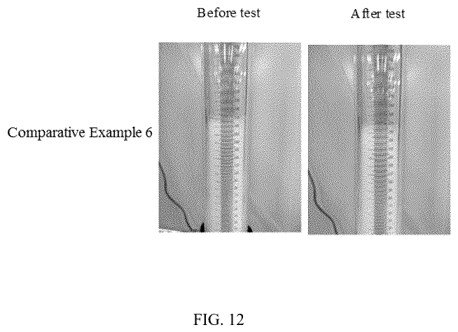

See FIGS. 9-12 for details. “Before test” corresponds to an initial mean value at 0 min, and “after test” corresponds to a mean value at 5 min.

TABLE 4

| | Initial mean value | Mean value at |
|---|---|---|
| Grouping | at 0 min (mm) | 5 min (mm) |
| Example 1 | 79 | 37 |
| Example 2 | 57 | 11 |
| Example 3 | 97 | 14 |
| Example 4 | 83 | 20 |
| Example 5 | 103 | 45 |
| Example 6 | 113 | 77 |
| Comparative | 165 | 163 |
| Example 1 | | |
| Comparative | 170 | 166 |
| Example 4 | | |
| Comparative | 159 | 154 |
| Example 5 | | |
| Comparative | 169 | 168 |
| Example 6 | | |

According to the test results, it can be seen that the laundry sheets of Examples 1-6 had a good detergency effect, and were rapidly dissolved, strongly adhered between the layers, and had a low amount of foam during cleaning, significantly superior to those of Comparative Examples 1-6 and 8 in all aspects.

This specific embodiment is only an explanation of the present application and is not a limitation of the present application. Those skilled in the art may make non-creative modifications to the present embodiment as needed after reading this specification, but as long as it falls within the scope of the claims of the present application, it is protected by the patent law.

What is claimed is:

1. A multi-layer laundry sheet, consisting of two or more single-layer laundry sheets by self-adhesion;
wherein at least one single-layer laundry sheet of the two or more single-layer laundry sheets is a first type of single-layer laundry sheet;
the first type of single-layer laundry sheet is prepared from a first slurry and, based on a weight percentage of the first slurry, the first slurry comprises the following raw materials:
10-30% of a first film-forming agent, 20-50% of a first anionic surfactant, 5-20% of a nonionic surfactant, 2-10% of an acidifying agent, 0.5-3% of a chelating agent, 0-5% of a first enzyme preparation, 1-5% of a first auxiliary agent, 0.5-5% of a first essence, and water;
the first film-forming agent comprises polyvinyl alcohol;
the first anionic surfactant comprises a high-foam anionic surfactant and a low-foam anionic surfactant; a weight ratio of the high-foam anionic surfactant to the low-foam anionic surfactant is (3-10):1;
the high-foam anionic surfactant comprises at least one of sodium alpha-alkenyl sulfonate, sodium fatty acid methyl ester sulfonate, or sodium lauroyl glutamate;
the low-foam anionic surfactant comprises at least one of sodium isomeric alcohol ether sulfate, sodium fatty acid methyl ester ethoxylate sulfonate, or sodium isooctanol sulfate; and
the nonionic surfactant comprises at least two of ethylene-oxide/propylene-oxide (EO/PO) block polyether, fatty acid methyl ester ethoxylate, secondary alcohol ethoxylate, or alkyl glycoside alkoxylate.

2. The multi-layer laundry sheet according to claim 1, wherein a weight ratio of the first anionic surfactant to the nonionic surfactant is (2-10):1.

3. The multi-layer laundry sheet according to claim 1, wherein the single-layer laundry sheet further comprises a second type of single-layer laundry sheet, wherein the second type of single-layer laundry sheet is prepared from a second slurry and, based on a weight percentage of the second slurry, the second slurry comprises the following raw materials: 3-20% of a second film-forming agent, 10-30% of a second anionic surfactant, 5-10% of a softening agent, 2-10% of a alkalizing agent, 0-5% of a second enzyme preparation, 1-5% of a second auxiliary agent, 0.5-5% of a second essence, and water;
the second film-forming agent comprises at least sodium alginate and carboxymethyl cellulose, a weight ratio of the sodium alginate to the carboxymethyl cellulose is (1-15):1; and
the second anionic surfactant comprises at least one of the sodium alpha-alkenyl sulfonate, sodium alkyl sulfate, sodium modified oil ethoxylate sulfonate, or the sodium fatty acid methyl ester sulfonate.

4. The multi-layer laundry sheet according to claim 3, wherein the acidifying agent comprises a C12-C18 fatty acid.

5. The multi-layer laundry sheet according to claim 3, wherein the alkalizing agent comprises at least one of sodium hydroxide, potassium hydroxide, sodium carbonate, potassium carbonate, sodium citrate, or potassium citrate.

6. The multi-layer laundry sheet according to claim 1, wherein the first type of single-layer laundry sheet is located at an outermost layer of the multi-layer laundry sheet.

7. The multi-layer laundry sheet according to claim 3, wherein the first type of single-layer laundry sheet is located at an outermost layer of the multi-layer laundry sheet, and the second type of single-layer laundry sheet is located at a middle of the multi-layer laundry sheet.

8. The multi-layer laundry sheet according to claim 3, wherein a thickness of the first type of single-layer laundry sheet is 0.3-3.5 mm, and a thickness of the second type of single-layer laundry sheet is 0.3-3.0 mm.

9. The multi-layer laundry sheet according to claim 1, wherein a first side of each of the two or more single-layer laundry sheets is a smooth side, a second side of each of the two or more single-layer laundry sheets is a rough side; and layers of the two or more single-layer laundry sheets of the multi-layer laundry sheet are self-adhered by the smooth side of one of the two or more single-layer laundry sheets and the rough side of another of the two or more single-layer laundry sheets.

10. A method for preparing the multi-layer laundry sheet according to claim 1, comprising the following steps:
step 1: preparing the first slurry, comprising the following steps:
step 1a: mixing and stirring the water and the first film-forming agent under a condition of 75-85° C., and after the first film-forming agent swells uniformly, adding the first anionic surfactant and stirring to dissolve uniformly; and
step 1b: then adding remaining raw materials of first slurry and stirring until uniform to obtain the first slurry;
step 2: when a second type of single-layer laundry sheet is comprised, then preparing a second slurry, comprising the following steps:
step 2a: mixing the water and a second film-forming agent, and fully swelling to a homogeneous viscous liquid under a condition of 20-30° C.;
step 2b: adding a second anionic surfactant and a second auxiliary agent under a condition of 38-45° C. and stirring to dissolve uniformly; and
step 2c: then adding remaining raw materials of the second slurry to obtain the second slurry;
when the second type of single-layer laundry sheet is not comprised, omitting the step 2, and performing step 3 after the step 1 is finished; and
the step 3: during a drying and forming stage of at least one of the first slurry for preparing the first type of single-layer laundry sheet or the second slurry for preparing the second type of single-layer laundry sheet, attaching another single-layer or multi-layer laundry sheet of the two or more single-layer laundry sheets that has completed the drying and forming stage, and then continuing drying to obtain the multi-layer laundry sheet.
